(19) United States
(12) Patent Application Publication
(10) Pub. No.: US 2017/0370883 A1
(43) Pub. Date: Dec. 28, 2017

(54) MULTI-SPOT CONTAMINANT DETECTION WITH MAGNETOSTRICTIVE SENSORS

(71) Applicant: Auburn University, Auburn, AL (US)

(72) Inventors: Bryan A. Chin, Auburn, AL (US); Shin Horikawa, Auburn, AL (US); Stevie R. Best, Montgomery, AL (US); I-Hsuan Chen, Auburn, AL (US); Howard C. Wikle, Auburn, AL (US); Zhongyang Cheng, Auburn, AL (US); Yuzhe Liu, Auburn, AL (US); Jiajia Hu, Auburn, AL (US); Fengen Wang, Auburn, AL (US)

(21) Appl. No.: 15/631,153

(22) Filed: Jun. 23, 2017

Related U.S. Application Data
(60) Provisional application No. 62/353,935, filed on Jun. 23, 2016.

(51) Int. Cl. G01N 27/74; A23L 3/00; G01F 23/296; G01F 23/00; B03C 1/033

(52) U.S. Cl. CPC G01N 27/74; G01F 23/0061; B03C 1/0335; G01F 23/2963; A23L 3/001; A23V 2002/00; G01N 2291/0256

(57) ABSTRACT

In at least one illustrative embodiment, a method for contaminant detection includes distributing multiple magnetostrictive sensors on a nonmagnetic index plate. The index plate includes multiple wells formed in a top surface that are each sized to receive a magnetostrictive sensor. The method further includes placing a magnetic backing plate below the index plate, inverting the index plate and the magnetic backing plate, and then placing the inverted index plate on a sample surface. The sample surface may be two-dimensional food such as fresh vegetable leaves. The method may further include placing the index plate and the magnetic backing plate on a nonmagnetic cover plate that is positioned above a sensor coil. The method further includes removing the magnetic backing plate, removing the index plate, and applying a varying magnetic field with the sensor coil to a magnetostrictive sensor positioned on the cover plate. Other embodiments are described and claimed.

### CROSS-REFERENCE TO RELATED APPLICATION

This application claims priority to U.S. Provisional Application Ser. No. 62/353,935, filed Jun. 23, 2016, the entire disclosure of which is hereby incorporated by reference.

### BACKGROUND

Foodborne illnesses are primarily caused by food contaminated with pathogenic microorganisms in the field or during food processing under unsanitary conditions. Hence, surveillance of bacterial contamination of fresh produce through the food supply chain is of great importance to the food industry. However, such surveillance is a challenge since the food supply chain is a lengthy trail with many opportunities to cause food contamination. Food products may be cleaned at the harvesting site, transported to a warehouse, re-cleaned, and repackaged several times before reaching retail outlets.

Typical microbiological methods for pathogen detection, such as colony counting, immunoassay, and polymerase chain reaction (PCR), offer very high sensitivities. However, they require pre-analytical sample preparation, which generally includes sample collecting, separating target pathogen cells from food, increasing cell concentration, and achieving analysis volume from bulk samples before detection. These processes are time consuming, resulting in delays in obtaining the screening results. Also, only small samples (for example, 1 mL samples) may be evaluated for pathogens. More importantly, food samples have to be delivered to laboratories for culture preparation and analysis. Label-free biosensors are available in today's market. However, they also require sample preparation prior to the actual testing (i.e. sampling from fresh produce, filtration and purification of the collected samples, and injection of the filtered/purified samples into a flow system where a biosensor resides). Due to the complexity of these test procedures and the requirements of expensive equipment and highly trained personnel, current food safety controls mainly rely on control of worker/environment hygiene in the food processing industry, rather than the direct pathogen detection.

Free-standing phage-based magnetoelastic biosensors have been investigated as a label-free wireless biosensor system for real-time pathogen detection. The magnetoelastic biosensor is typically composed of a magnetoelastic resonator that is coated with a bio-molecular recognition element that binds specifically with a target pathogen. Once the biosensor comes into contact with the target pathogen, binding occurs, causing an increase in the mass of the resonator resulting in a decrease in the resonant frequency of the sensor (as well as other characteristic frequencies of the sensor).

### SUMMARY

According to one aspect, a method for contaminant detection includes distributing a plurality of magnetostrictive sensors on a top surface of a nonmagnetic index plate, wherein the index plate has an array of wells formed in the top surface, wherein each well is sized to receive a magnetostrictive sensor; placing a magnetic backing plate below the index plate in response to distributing the plurality of magnetostrictive sensors; inverting the index plate and the magnetic backing plate in response to placing the magnetic backing plate below the index plate; and placing the index plate on a sample surface in response to inverting the index plate and the magnetic backing plate.

In some embodiments, the sample surface may include two-dimensional food. In some embodiments, the method may further include pressing the index plate downward on the sample surface. In some embodiments, the method may further include applying a uniform magnetic field to the magnetostrictive sensors in response to distributing the plurality of magnetostrictive sensors on the index plate; and vibrating the index plate in response to applying the uniform magnetic field.

In some embodiments, the method may further include placing the index plate and the magnetic backing plate on a nonmagnetic cover plate in response to placing the index plate on the sample surface, wherein the cover plate is positioned above a first sensor coil; removing the magnetic backing plate from the index plate in response to placing the index plate on the nonmagnetic cover plate; removing the index plate from the nonmagnetic cover plate in response to removing the magnetic backing plate; applying a varying magnetic field, using the first sensor coil, to a first magnetostrictive sensor positioned on the nonmagnetic cover plate in response to removing the index plate; and detecting a frequency response of the first magnetostrictive sensor using the first sensor coil while applying the varying magnetic field. In some embodiments, the method may further include determining whether a microorganism is present based on the frequency response of the first magnetostrictive sensor, wherein the first magnetostrictive sensor comprises a biorecognition element.

In some embodiments, the method may further include positioning the first sensor coil beneath the first magnetostrictive sensor, wherein applying the varying magnetic field comprises applying the varying magnetic field in response to positioning the first sensor coil. In some embodiments, the method may further include positioning the first sensor coil beneath a second magnetostrictive sensor positioned on the nonmagnetic cover plate in response to detecting a frequency response of the first magnetostrictive sensor; applying a varying magnetic field, using the first sensor coil, to the second magnetostrictive sensor in response to positioning the first sensor coil; and detecting a frequency response of the second magnetostrictive sensor using the first sensor coil while applying the varying magnetic field.

In some embodiments, the cover plate may be positioned above an array of sensor coils that includes the first sensor coil, and wherein each sensor coil of the array of sensor coils is aligned with a magnetostrictive sensor. In some embodiments, the method may further include selecting the first sensor coil from the array of sensor coils with a low-loss radio-frequency switch, wherein applying the varying magnetic field comprises applying the varying magnetic field in response to selecting the first sensor coil. In some embodiments, the radio-frequency switch may include a solid-state semiconductor switch. In some embodiments, the array of sensor coils may be a two-dimensional array, and selecting the first sensor coil may further include selecting the first sensor coil with a second low-loss radio frequency switch.

According to another aspect, a system for contaminant detection may include a nonmagnetic cover plate and an array of sensor coils positioned below the nonmagnetic cover plate. The system may further include a controller coupled to the array of sensor coils. The controller is to select a first sensor coil of the array of sensor coils, wherein the first sensor coil is positioned below a first magnetostrictive sensor that is positioned on top of the nonmagnetic cover plate; apply a varying magnetic field with the first sensor coil to the first mangetostrictive sensor in response to selection of the first sensor coil; and detect a frequency response of the first magnetostrictive sensor with the first sensor coil during application of the varying magnetic field. In some embodiments, the controller may be further to determine whether a microorganism is present based on the frequency response of the first magnetostrictive sensor, wherein the first magnetostrictive sensor comprises a biorecognition element.

In some embodiments, the controller may be further to select a second sensor coil of the array of sensor coils in response to detection of the frequency response of the first magnetostrictive sensor, wherein the second sensor coil is positioned below a second magnetostrictive sensor that is positioned on top of the nonmagnetic cover plate; apply a varying magnetic field with the second sensor coil to the second mangetostrictive sensor in response to selection of the second sensor coil; and detect a frequency response of the second magnetostrictive sensor with the second sensor coil during application of the varying magnetic field.

In some embodiments, the array of sensor coils may be a linear array. In some embodiments, the array of sensor coils may be a two-dimensional array. In some embodiments, to select the first sensor coil may include to select the first sensor coil with a low-loss radio-frequency switch. In some embodiments, the radio-frequency switch may include a solid-state semiconductor switch.

In some embodiments, the array of sensor coils may be a two-dimensional array, and to select the first sensor coil may include to select the first sensor coil with a first low-loss radio-frequency switch and a second low-loss radio-frequency switch. In some embodiments, each of the first switch and the second switch may include a single-pole, multiple throw switch, each sensor coil of the array of sensor coils may include a first terminal and a second terminal. The two-dimensional array of sensor coils may include a plurality of rows and a plurality of columns, wherein each first terminal of the sensor coils in a row is coupled to a corresponding output terminal of the first switch, and wherein each second terminal of the sensor coils in a column is coupled to a corresponding output terminal of the second switch. To select the first sensor coil may include to select a row that includes the first sensor coil with the first switch and a column that includes the first sensor coil with the second switch.

### BRIEF DESCRIPTION OF THE DRAWINGS

The concepts described in the present disclosure are illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. The detailed description particularly refers to the accompanying figures in which:

FIG. 1 is a simplified schematic diagram of a magnetostrictive sensor assembly;

FIG. 2 is another simplified schematic diagram of the magnetostrictive sensor assembly of FIG. 1;

FIG. 3 is a simplified cross-sectional diagram of a magnetostrictive sensor of the magnetostrictive sensor assembly of FIGS. 1 and 2;

FIG. 4 is a simplified schematic diagram of a system for detecting pathogens that includes the magnetostrictive sensor assembly of FIGS. 1-3;

FIG. 5 is a simplified top view of the system of FIG. 4;

FIG. 6 is a simplified top view of another embodiment of the system of FIG. 4;

FIG. 7 is a simplified schematic diagram of a sensor coil array of the system of FIGS. 4-6; and

FIGS. 8A and 8B are a simplified flow diagram of one embodiment of a method for pathogen detection that may be performed using the magnetostrictive sensor assembly and system of FIGS. 1-7.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the present disclosure.

References in the specification to “one embodiment,” “an embodiment,” “an example embodiment,” etcetera, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

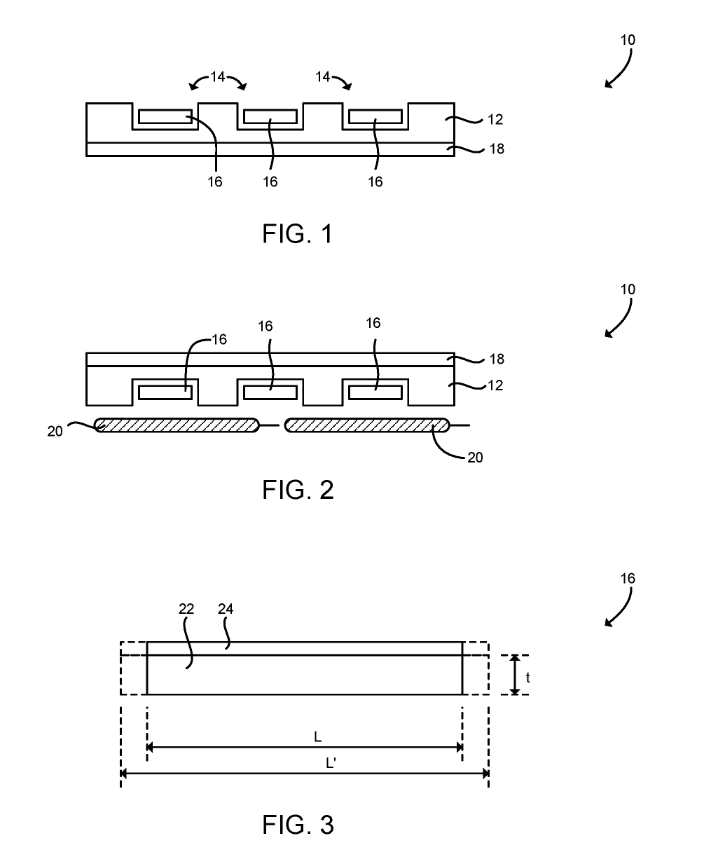

Referring now to FIG. 1, a simplified schematic diagram of one illustrative embodiment of a magnetostrictive sensor assembly 10 is shown. The magnetostrictive sensor assembly 10 includes an index plate 12. The index plate 12 may be embodied as a non-magnetic material such as silicon or glass. The index plate 12 includes multiple wells 14 formed in the top surface of the index plate 12. The wells 14 may be rectangular in shape and may be arranged on the index plate 12 in a regular pattern, such as a rectangular grid array. The wells 14 may be etched into the top surface of the index plate 12. Each of the wells 14 is sized to receive a magnetostrictive sensor 16. Because the magnetostrictive sensors 16 are also rectangular, the wells 14 hold the magnetostrictive sensors 16 in a predetermined orientation, which may improve wireless detection of microorganisms or other pathogens, as described further below. As described further below, the magnetostrictive sensor assembly 10 may be used to measure many spots on a sample surface for contamination at once. Additionally, the spacing of the wells 14 may ensure that placement of the sensors 16 may be reliably replicated.

The magnetostrictive sensors 16 are small devices made of a magnetostrictive and/or magnetoelastic material that may be coated with a biorecognition element that binds to a particular target particle, such as a pathogen. For example, the biorecognition element may include antibodies or genetically engineered phages that bind to particular bacteria, such as Salmonella Typhimurium. The magnetostrictive material converts magnetic energy to mechanical energy and vice versa. In other words, magnetostrictive materials generate mechanical strain when the magnetic energy is applied and generate magnetic energy in response to mechanical strain. Throughout this disclosure, the terms magnetostrictive material and magnetoelastic material may be used interchangeably. In the illustrative embodiment, the magnetostrictive sensors 16 are embodied as thin strips of material that may be actuated into resonance by application of a varying magnetic field. The magnetostrictive sensors 16 are illustratively rectangular in shape; however, in other embodiments, any elongated shape may be used. Upon contact with the specific target pathogen, the pathogen binds with the biorecognition element and increases the mass of the magnetostrictive sensor 16. This additional mass causes the characteristic frequency of the magnetostrictive sensors 16 to decrease. As described further below, the characteristic frequency may be measured by a sensor coil, allowing quantitative detection and characterization of the pathogen. One embodiment of a magnetostrictive sensor 16 is further described below in connection with FIG. 3.

The magnetostrictive sensor assembly 10 further includes a magnetic backing plate 18 positioned below the index plate 12. The magnetic backing plate 18 may be embodied as a magnetic glass sheet, a permanent magnet, or other magnetic material. The magnetic backing plate 18 generates a magnetic field that holds the magnetostrictive sensors 16 against the index plate 12, within the wells 14.

Referring now to FIG. 2, the magnetostrictive sensor assembly 10 may be inverted so that the magnetic backing plate 18 is positioned above the index plate 12. While inverted, the magnetic field generated by the magnetic backing plate 18 continues to hold the sensors 16 against the index plate 12 within the wells 14, overcoming the force of gravity pulling the sensors 16 downward.

As shown in FIG. 2, the magnetostrictive sensor assembly 10 may be placed onto a surface to be tested for contaminants, which is illustratively a two-dimensional food 20. The two-dimensional food 20 may be embodied as fresh leaves (e.g., lettuce leaves or other fresh vegetable leaves) or any other substantially planar food item. When placed on the two-dimensional food 20, the magnetostrictive sensor assembly 10 may cause the two-dimensional food 20 to flatten and contact the sensors 16. The magnetostrictive sensor assembly 10 may also be pressed down against the two-dimensional food 20 with an external force to cause the sensors 16 to physically contact the surface of the two-dimensional food 20. Of course, although illustrated as two-dimensional food 20, it should be understood that the magnetostrictive sensor assembly 10 may be used to simultaneously test multiple spot locations on other types of sample surfaces.

Referring now to FIG. 3, a simplified schematic diagram of one illustrative embodiment of a magnetostrictive sensor 16 of the magnetostrictive sensor assembly 10 is shown. The sensor 16 includes a body 22 coated with an immobilized biorecognition element 24. The body 22 is made from a magnetoelastic material, such as a magnetostrictive alloy. In one illustrative embodiment, the body 22 may be mechanically polished and cut (diced) from a strip of METGLAS™ 2826MB, which is commercially available from Honeywell Inc., of Conway, S.C. Additionally, although illustrated as including a single side of the body 22 coated with the biorecognition element 24, it should be understood that in some embodiments two or more sides of the body 22 may be coated with the biorecognition element 24.

In the illustrative embodiment, each magnetostrictive sensor 16 has a length L, a thickness t, and a width w (not shown). For example, in some embodiments the magnetostrictive sensors 16 may be one millimeter in length, four millimeters in length, or another length. The magnetostrictive sensor 16 is in the shape of a thin strip, meaning that the length L is larger than the width w and much larger than the thickness t (i.e., L>w>>t). Upon application of a varying magnetic field, the dimensions of the magnetostrictive sensor 16 change. Accordingly, the magnetostrictive sensor 16 mechanically vibrates in response to the varying magnetic field. In particular, due to its thin strip shape, the magnetostrictive sensor 16 vibrates mainly longitudinally; in other words, when an oscillating external magnetic field is applied, the magnetostrictive sensor 16 vibrates between the length L and a length L′. The fundamental resonant frequency of this longitudinal oscillation is given as:

$${f}_{0} = \frac{V}{2 L} , \qquad ( 1 )$$

where V is the acoustic velocity of the material along its length L. Addition of a small mass (Δm<<M) on the magnetostrictive sensor 16 surface causes a change in the resonant frequency (Δf). This resonant frequency change is proportional to the initial frequency f₀ and the mass added (Δm) and is inversely proportional to the initial sensor mass M. Assuming the added mass is uniformly distributed on the surface of the magnetostrictive sensor 16, the resonant frequency change may be approximated as:

$$Δ f = - \frac{{f}_{0} Δ m}{2 M} \\ ( Δ m ≪ M ) . \qquad ( 2 )$$

The negative sign in Equation (2) means that the resonant frequency of the magnetostrictive sensor 16 decreases with the increase of the mass load. The additional mass load on the magnetostrictive sensor 16 can be obtained by measuring the shift in the resonant frequency (or another characteristic frequency related to the resonant frequency).

When the magnetostrictive sensor 16 comes into contact with a target pathogen, the biorecognition element 24 immobilized on the magnetostrictive sensor 16 surface will bind/capture the target pathogen. This adds an additional mass load on the magnetostrictive sensor 16. As described above, this additional mass causes a drop in a characteristic frequency of the magnetostrictive sensor 16. Therefore, the presence of any target pathogens can be identified by monitoring for a shift in the characteristic frequency of the magnetostrictive sensor 16. Additionally or alternatively, rather than a biorecognition element 24, the magnetostrictive sensor 16 may include a chemical layer that similarly binds with one or more contaminants such as mercury or heavy metals.

The simple strip-shaped configuration of the illustrative magnetostrictive sensor 16 described above may make fabrication relatively easy and/or inexpensive. Additionally, the magnetostrictive sensors 16 are passive sensors that do not require on-board power. As described above, the magnetostrictive sensor 16 may be fabricated by mechanical methods (e.g., polish and dice) or by microelectronics fabrication methods (e.g., sputter deposit, thermal deposit, or electrochemical deposit). These methods can mass-produce fabricated magnetostrictive sensors 16 with very low cost. Additional details of illustrative magnetoelastic ligand detectors are described in U.S. Pat. No. 7,759,134 (“Magnetostrictive Ligand Sensor”), the entire disclosure of which is incorporated herein by reference.

As described above, the biorecognition element 24 may be immobilized on the surface of each magnetostrictive sensor 16 to bind a specific target pathogen. In some embodiments, the biorecognition element 24 may be embodied as a chemical binding element or an interaction layer immobilized on the body 22 of the magnetostrictive sensor 16. For example, the biorecognition element 24 may be a traditional antibody. Additionally or alternatively, in some embodiments, the biorecognition element 24 may be a genetically engineered bacteriophage (“phage”). The use of phages as a substitute for antibodies offers a stable, reproducible, and inexpensive alternative. In particular, phages have high affinity for binding with target pathogen cells, the phage structure is robust and stable, and phages may bind target pathogens in air with certain humidity. Additionally or alternatively, the biorecognition element 24 may be embodied as DNA, RNA, proteins, aptamers, or other biorecognition elements. Specific ligand recognition devices that may be illustratively used as the biorecognition element 24, as well as illustrative application methods, are discussed in U.S. Pat. No. 7,138,238 (“Ligand Sensor Devices and Uses Thereof”), U.S. Pat. No. 7,267,993 (“Phage Ligand Sensor Devices and Uses Thereof”), and U.S. Pat. No. 7,670,765 (“Method of Forming Monolayers of Phage-Derived Products and Used Thereof”), the entire disclosures of which are incorporated herein by reference.

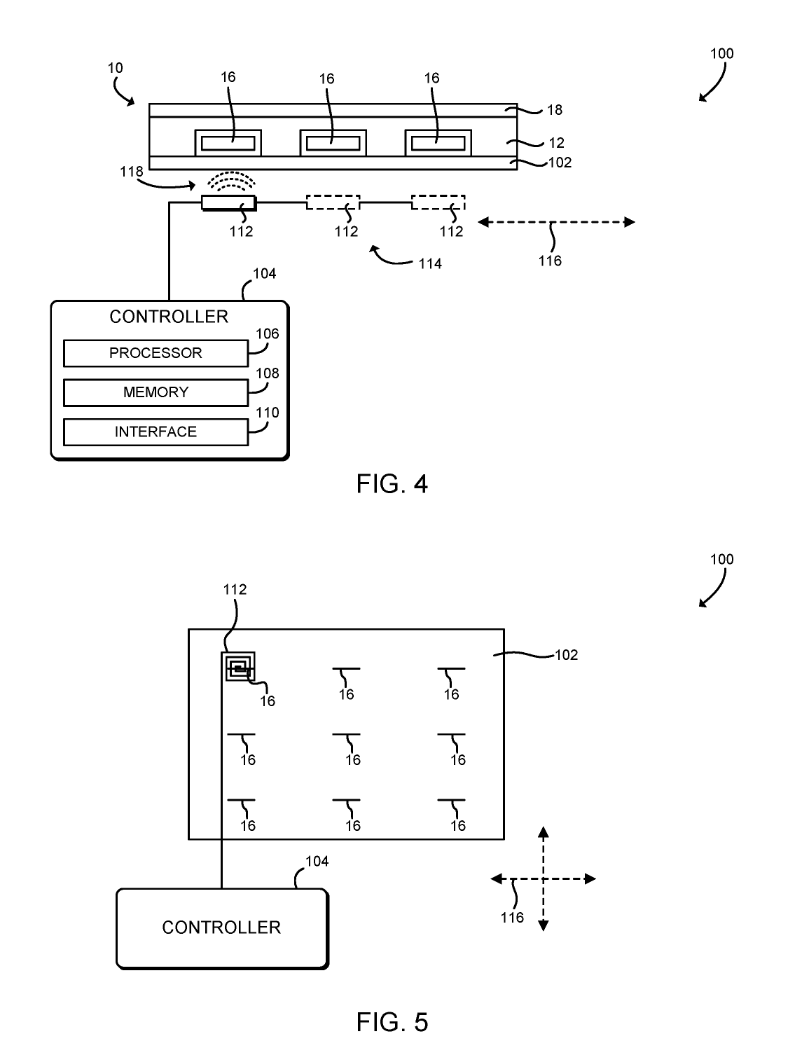

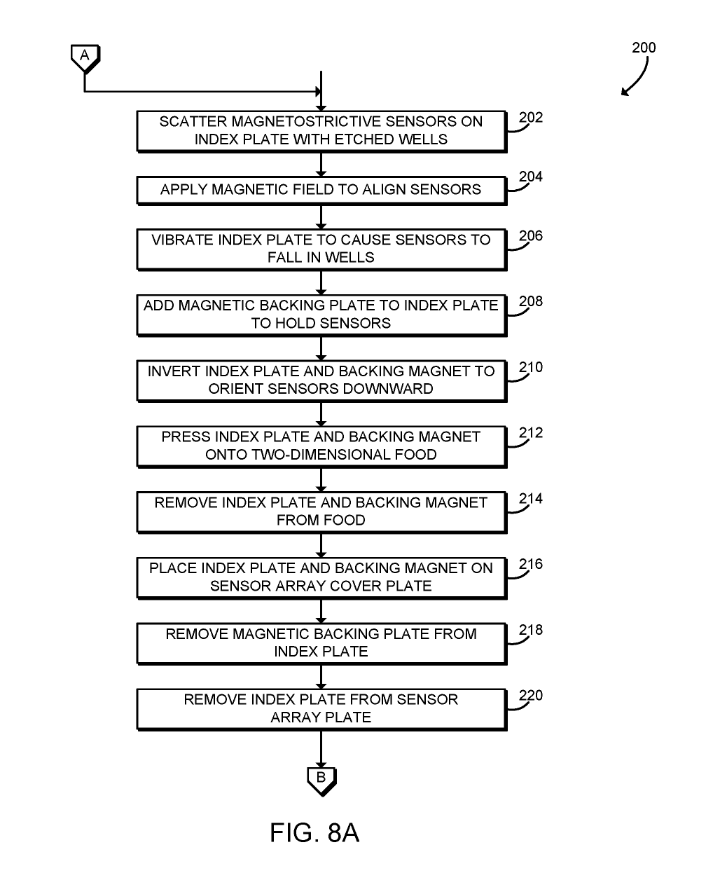

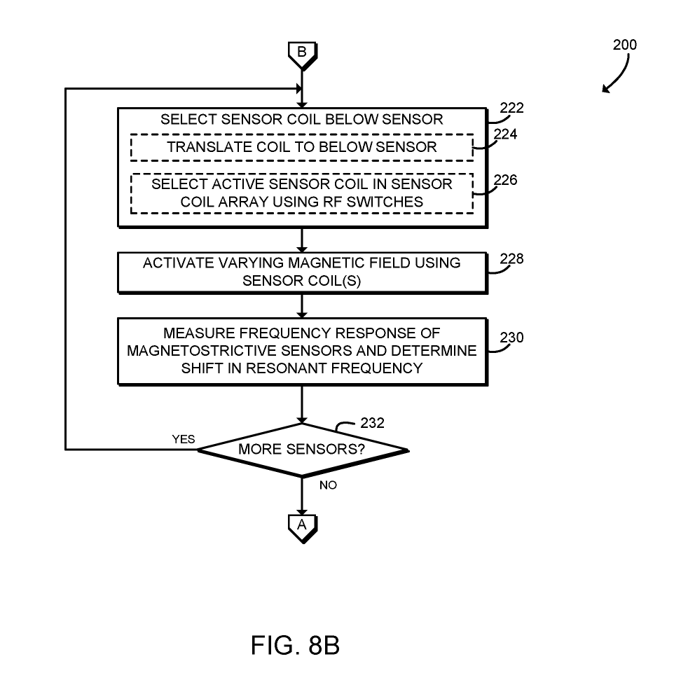

Referring now to FIG. 4, a simplified schematic diagram of one illustrative embodiment of a system 100 for detecting pathogens is shown. The system 100 includes a magnetostrictive sensor assembly 10 that has been inverted as shown in FIG. 2. The magnetostrictive sensor assembly 10 is positioned on top of a non-magnetic cover plate 102. For example, as described further below in connection with FIGS. 8A and 8B, the magnetostrictive sensor assembly 10 may be placed on the cover plate 102 after being pressed onto a sample surface such as the two-dimensional food 20. The cover plate 102 may be embodied as a nonmagnetic material such as glass.

The system 100 also includes a controller 104 coupled to one or more sensor coils 112. The sensor coils 112 may be arranged in an array 114, which may be embodied as a linear array, a two-dimensional array, a three-dimensional array, or another regular arrangement of sensor coils 112. Each of the sensor coils 112 may be positioned beneath a well 14 of the index plate 12 and therefore also beneath a magnetostrictive sensor 16. The sensor coils 112 and/or the index plate 12 may be translatable (e.g., in one, two, or three dimensions) to position a sensor coil 112 beneath a particular well 14, as shown by the arrows 116 of FIGS. 4 and 5. As described further below, the controller 104 causes the sensor coil 112 to apply a varying magnetic field 118 to a magnetostrictive sensor 16. In some embodiments, the controller 104 may also select or otherwise activate a particular sensor coil 112 of the array 114. The controller 104 measures a magnetic field produced by the magnetostrictive sensor 16 in response to the varying magnetic field 118 using the sensor coil 112. The controller 104 determines a frequency response of the magnetostrictive sensor 16 based on the measured magnetic field. This frequency response is related to the resonant frequency of the magnetostrictive sensor 16, as well as other material properties (e.g., the magnetoelastic coupling coefficient) and the environment (e.g., friction forces or damping effects). As described further below, microorganisms or other pathogens bound to the magnetostrictive sensors 16 may cause an increase in the mass of the magnetostrictive sensors 16 and a corresponding decrease in the frequency response. The system 100 may determine whether microorganisms or other pathogens are present by determining whether the frequency response shifts. Multiple types of pathogens may be detected simultaneously by using separate groups of magnetostrictive sensors 16, with each group of magnetostrictive sensors 16 binding to a different type of microorganism or other pathogen.

As described briefly above, the system 100 includes the controller 104. The controller 104 is responsible for activating or energizing electronically-controlled components of the system 100, including the sensor coil 112. The controller 104 is also responsible for interpreting electrical signals received from components of the system 100, including the sensor coil 112. To do so, the controller 104 may include a number of electronic components commonly associated with units utilized in the control of electronic and electromechanical systems. For example, the controller 104 may include, amongst other components customarily included in such devices, a processor 106 and a memory device 108. The processor 106 may be any type of device capable of executing software or firmware, such as a microcontroller, microprocessor, digital signal processor, or the like. The memory device 108 may be embodied as one or more non-transitory, machine-readable media. The memory device 108 is provided to store, amongst other things, instructions in the form of, for example, a software routine (or routines) which, when executed by the processor 106, allows the controller 104 to perform sensor interrogation and pathogen detection using the other components of the system 100.

The controller 104 also includes an analog interface circuit 110, which may be embodied as any electrical circuit(s), component, or collection of components capable of performing the functions described herein. The analog interface circuit 110 converts output signals (e.g., from the sensor coil 112) into signals which are suitable for presentation to an input of the processor 106. In particular, the analog interface circuit 110, by use of a network analyzer, an analog-to-digital (A/D) converter, or the like, converts analog signals into digital signals for use by the processor 106. Similarly, the analog interface circuit 110 converts signals from the processor 106 into output signals which are suitable for presentation to the electrically-controlled components associated with system 100 (e.g., the sensor coil 112). In particular, the analog interface circuit 110, by use of a variable-frequency signal generator, digital-to-analog (D/A) converter, or the like, converts digital signals generated by the processor 106 into analog signals for use by the electronically-controlled components associated with the system 100. It is contemplated that, in some embodiments, the analog interface circuit 110 (or portions thereof) may be integrated into the processor 106.

As also mentioned above, the controller 104 is coupled to the sensor coil 112. In the illustrative embodiment, the sensor coil 112 is used as an energizing excitation source for the magnetostrictive sensors 16 and as a detector of signals received from the magnetostrictive sensors 16. In some embodiments, the sensor coil 112 may be a solenoid with loops having a generally rectangular cross-section. In some embodiments, the sensor coil 112 may be embodied as a flat coil as described in U.S. Patent Publication No. 2014/0120524 (“In-Situ Pathogen Detection Using Magnetoelastic Sensors”), the entire disclosure of which is incorporated herein by reference. To improve performance of the system 100, the sensor coil 112 may be impedance-matched to the electrical circuitry of the controller 104. Additionally, although illustrated as a single sensor coil 112, it should be understood that in some embodiments the system 100 may include a separate drive coil and one or more pickup coils to perform the functions of the sensor coil 112.

The system 100 may further include a magnetic field generator configured to generate a constant, uniform magnetic field. The uniform magnetic field extends through the wells 14. The uniform magnetic field may bias the magnetostrictive sensors 16 during application of the varying magnetic field 118, increasing the magnitude of the frequency response. The magnetic field generator may be embodied as any component capable of generating the uniform magnetic field, for example, a pair of permanent magnet arrays or a Helmholtz coil.

Referring now to FIG. 5, a top-view schematic diagram of the system 100 is shown. In the illustrative view of FIG. 5, the magnetic backing plate 18 and the index plate 12 have been removed from the cover plate 102. Because the magnetic field generated by the magnetic backing plate 18 was removed, the sensors 16 have fallen out of the wells 14 onto the cover plate 102. Thus, the sensors 16 remain positioned on the cover plate 102 in the same arrangement as the wells 14 of the index plate 12, which is illustratively a rectangular grid array as shown in FIG. 5. As further shown in FIG. 5, in some embodiments, a single sensor coil 112 may be positionable below each of the sensors 16 by translating the sensor coil 112 and/or the cover plate 102, as illustrated by the arrows 116.

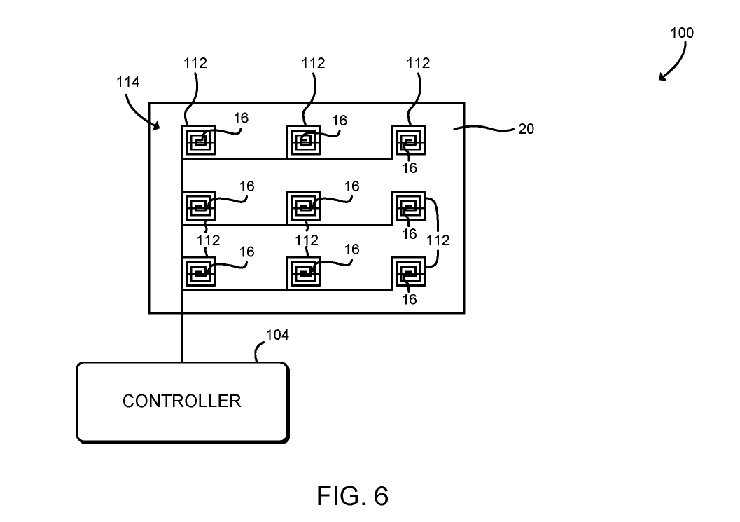

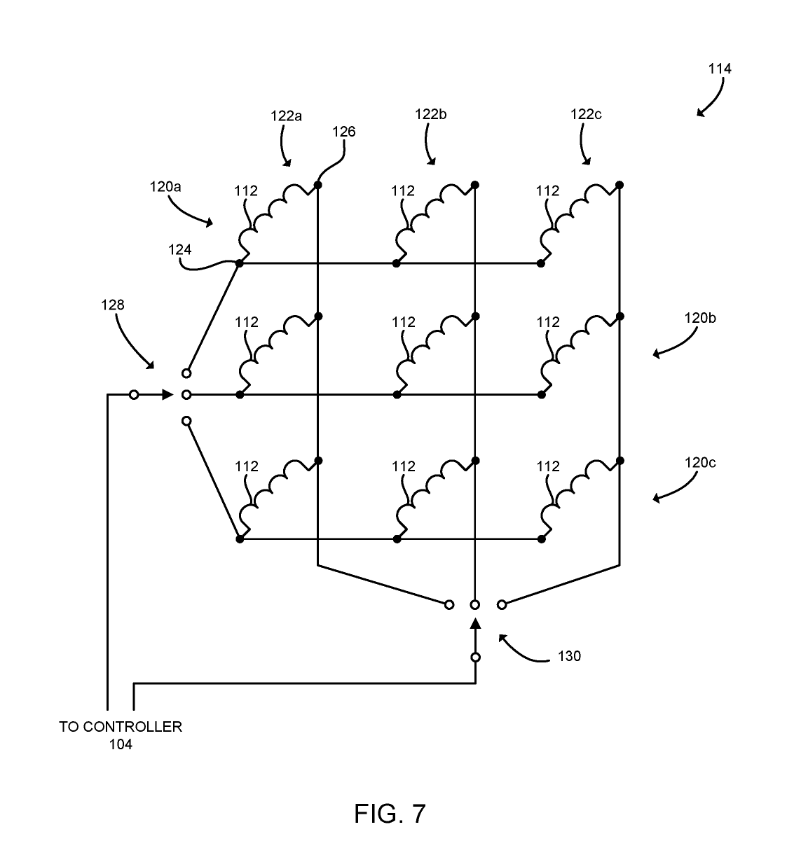

Referring now to FIG. 6, a top-view schematic diagram of another embodiment of the system 100 is shown. In the embodiment of FIG. 6, the controller 104 is coupled to an array 114 of sensor coils 112. Illustratively, the array 114 is embodied as a rectangular grid array of sensor coils 112; however, in other embodiments the array 114 may be embodied as a linear array, a three-dimensional array, or another regular arrangement of sensor coils 112. In some embodiments, the controller 104 may select or otherwise activate a particular sensor coil 112 using a switched array 114. One embodiment of a switched array 114 is described further below in connection with FIG. 7.

Referring now to FIG. 7, a schematic diagram of an array 114 of sensor coils 112 is shown. The array 114 is illustratively a rectangular grid array of nine sensor coils 112 including three rows 120 and three columns 122. Each of the sensor coils 112 includes two terminals 124, 126. The array 114 further includes two single-pole, multi-throw switches 128, 130. Each of the switches 128, 130 may be embodied as a low-loss, bidirectional radio frequency (RF) switch, such as a solid-state semiconductor switch. As shown, for each row 120 of sensor coils 112, the terminal 124 of each sensor coil 112 is connected to the same output terminal of the RF switch 128. For example, the terminal 124 of each sensor coil 112 in the row 120a is connected to one output terminal, the terminal 124 of each sensor coil 112 in the row 120b is connected to another output terminal, and so on. Similarly, for each column 122 of sensor coils 112, the terminal 126 of each sensor coil 112 is connected to the same output terminal of the RF switch 130. For example, the terminal 126 of each sensor coil 112 in the column 122a is connected to one output terminal, the terminal 126 of each sensor coil 112 in the row 122b is connected to another output terminal, and so on. As described further below, a particular sensor coil 112 may be selected or otherwise activated by configuring the switches 128, 130 to complete a circuit to the corresponding row 120 and column 122 that include the particular sensor coil 112. Additionally, although illustrated as a two-dimensional array 114, it should be understood that in other embodiments the array 114 may have a different number of dimensions and a corresponding number of switches (e.g., one switch for a linear array, three switches for a three-dimensional array, and so on).

Referring now to FIGS. 8A and 8B, one illustrative embodiment of a method 200 that may be used for pathogen detection with the magnetostrictive sensor assembly 10 and the system 100 is shown as a simplified flow diagram. The method 200 is illustrated as a series of blocks 202-232, some of which may be optionally performed in some embodiments (and, thus, are shown in dashed lines). It will be appreciated by those of skill in the art that some embodiments of the method 200 may include additional or different processes and sub-processes.

The method 200 begins with block 202, in which multiple magnetostrictive sensors 16 are scattered or otherwise distributed on the index plate 12. In block 204, a uniform magnetic field is applied to align the magnetic sensors 16. The magnetic field aligns with the length dimension of the wells 14 of the index plate 12, causing the sensors 16 to align in the same direction. In block 206, the index plate 12 is vibrated to cause the sensors 16 to fall into the wells 14. Thus, after being vibrated, the sensors 16 are aligned in the same orientation and are positioned in a predetermined pattern by the wells 14. For example, the sensors 16 may be positioned in a rectangular grid array.

In block 208, the magnetic backing plate 18 is added to the back side of the index plate 12. The magnetic backing plate 18 creates a magnetic field that attracts the sensors 16 and holds the sensors 16 against the index plate 12 within the wells 14. After adding the backing plate 18, the magnetostrictive sensor assembly 10 may be complete as illustrated in FIG. 1. It should be understood that in some embodiments, the magnetic backing plate 18 and the index plate 12 may have been pre-assembled prior to the distribution of the sensors 16.

In block 210, the magnetostrictive sensor assembly 10 (including the index plate 12 and the magnetic backing plate 18) is inverted. As described above, the magnetic field generated by the magnetic backing plate 18 holds the sensors 16 against the index plate 12 within the wells 14, even when the magnetostrictive sensor assembly 10 is inverted. After being inverted, the openings of the wells 14 are oriented downwards, allowing access from below to the sensors 16.

In block 212, the magnetostrictive sensor assembly 10 (including the index plate 12 and the magnetic backing plate 18) is pressed down onto two-dimensional food 20 or another sample surface to be tested for contamination. The magnetostrictive sensor assembly 10 may be pressed against the two-dimensional food 20 as illustrated in FIG. 2. The magnetostrictive sensor assembly 10 may be pressed down with the force of gravity or with additional, external force. As described above, when pressed against the two-dimensional food 20, the two-dimensional food 20 may flatten and come into contact with the magnetostrictive sensors 16. Thus, the magnetostrictive sensors 16 may simultaneously contact multiple spots on the two-dimensional food 20 to test for contamination.

In block 214, the magnetostrictive sensor assembly 10 (including the index plate 12 and the magnetic backing plate 18) is removed from the two-dimensional food 20 or other sample surface. In block 216, the magnetostrictive sensor assembly 10 (including the index plate 12 and the magnetic backing plate 18) is placed on the non-magnetic cover plate 102 of the system 100. As shown in FIG. 4, the magnetostrictive sensor assembly 10 remains in the inverted orientation when placed on the cover plate 102.

In block 218, the magnetic backing plate 18 is removed from the index plate 12. After removing the magnetic backing plate 18, the magnetic field is removed from the magnetostrictive sensors 16. Thus, the magnetostrictive sensors 16 may fall onto the cover plate 102. In block 220, the index plate 12 is removed from the cover plate 102. After removal of the index plate 12, the magnetostrictive sensors 16 remain arranged on the cover plate 102 in the same arrangement as the wells 14 of the index plate 12. For example, as shown in FIGS. 5 and 6, the sensors 16 may be arranged in a rectangular grid array.

Referring now to FIG. 8B, in block 222 the controller 104 may select or otherwise activate a sensor coil 112 beneath a magnetostrictive sensor 16. In some embodiments, in block 224 the controller 104 may cause the sensor coil 112 and/or the cover plate 102 to translate to position the magnetostrictive sensor 16 above the active sensor coil 112. The controller 104 may control a translation stage or other actuator to translate the sensor coil 112 and/or the cover plate 102. For example, in embodiments with a single sensor coil 112, the controller 104 may sequentially position the sensor coil 112 under each of the magnetostrictive sensors 16. As another example, in embodiments with an array 114 of multiple sensor coils 112, the controller 104 may align the array 114 so that the sensor coils 112 are each positioned beneath a magnetostrictive sensor 16.

In some embodiments, in block 226 the controller 104 may select the active sensor coil 112 in an array 114 of sensor coils 112 using one or more RF switches. For example, as shown in FIG. 7, the controller 104 may configure the RF switch 128 to select the row 120 that includes the selected sensor coil 112 and configure the RF switch 130 to select the column 122 that includes the selected sensor coil 112, completing a circuit with the selected sensor coil 112. By using RF switches to select among multiple sensor coils 112, the system 100 may support rapid measurement of multiple sensors 16 with a single controller 104, network analyzer, or other RF signal analyzer.

In block 228, the controller 104 activates the sensor coil 112 to generate the varying magnetic field 118. As described above, the varying magnetic field 118 causes the magnetostrictive sensors 16 to oscillate. Because the magnetostrictive sensors 16 were aligned by the wells 14 in a predetermined orientation, the longitudinal oscillation of all (or, at least, most) of the sensors 16 may be in the same direction. Thus, the magnetic flux picked up by the sensor coil 112 may thus contain frequency response information for all (or, at least, most) of the sensors 16. The frequency of the varying magnetic field 118 may be varied through a range of frequencies. The range of frequencies may include a resonant frequency of the magnetostrictive sensors 16 when a microorganism has not been bound (i.e., when the sensors 16 are unloaded). For example, in some embodiments the range of frequencies applied by the sensor coil 112 may cover from 50% of unloaded resonant frequency to slightly more than the unloaded resonant frequency. Binding of microorganisms on the magnetostrictive sensor 16 surface is typically a small mass change, and the decrease in the characteristic frequency of the magnetostrictive sensors 16 due to this small mass change is normally less than 50% of the unloaded resonant frequency of the magnetostrictive sensor 16.

In block 230, the controller 104 measures the frequency response of the magnetostrictive sensors 16 using the sensor coil 112, and any shift in resonant frequency of the magnetostrictive sensors 16 is determined. The controller 104 may monitor the characteristic frequency in real time or record data for later analysis. The measurement of each magnetostrictive sensor 16 may require about 2 seconds. As described above, the magnetostrictive sensors 16 include the biorecognition element 24 that will bind with microorganisms upon contact. Binding increases the mass of the magnetostrictive sensor 16, which causes a resonant frequency of the magnetostrictive sensor 16 to decrease. Thus, a measured shift in the resonant frequency indicates that microorganisms are present on the magnetostrictive sensor 16. In some embodiments, the sensors 16 may be preselected with the same resonant frequency, and thus the system 100 may only measure the final frequency response of the sensors 16 to determine the shift in resonant frequency. Additionally or alternatively, in some embodiments, the shift in resonant frequency may be determined by taking an initial measurement of the resonant frequency of the magnetic sensors 16 before they are put into contact with the two-dimensional food 20 as described above in connection with block 212 of FIG. 8A and then comparing the initial measurement to the current measurement of the frequency response.

In block 232, the controller 104 determines whether additional magnetostrictive sensors 16 should be measured. For example, the controller 104 may determine whether additional magnetostrictive sensors 16 remain in a pre-programmed pattern corresponding to the wells 14 of the index plate 12. If additional magnetostrictive sensors 16 remain to be measured, the method 200 loops back to block 222, in which a sensor coil 112 may be selected beneath another magnetostrictive sensor 16, for example by translating the sensor coil and/or cover plate 102 or by configuring the switched array 114. If no further magnetostrictive sensors 16 remain to be measured, the method 200 may loop back to block 202 to perform measurement of another sample.

While certain illustrative embodiments have been described in detail in the figures and the foregoing description, such an illustration and description is to be considered as exemplary and not restrictive in character, it being understood that only illustrative embodiments have been shown and described and that all changes and modifications that come within the spirit of the disclosure are desired to be protected. There are a plurality of advantages of the present disclosure arising from the various features of the apparatus, systems, and methods described herein. It will be noted that alternative embodiments of the apparatus, systems, and methods of the present disclosure may not include all of the features described yet still benefit from at least some of the advantages of such features. Those of ordinary skill in the art may readily devise their own implementations of the apparatus, systems, and methods that incorporate one or more of the features of the present disclosure.

1. A method for contaminant detection, the method comprising:
distributing a plurality of magnetostrictive sensors on a top surface of a nonmagnetic index plate, wherein the index plate has an array of wells formed in the top surface, wherein each well is sized to receive a magnetostrictive sensor;
placing a magnetic backing plate below the index plate in response to distributing the plurality of magnetostrictive sensors;
inverting the index plate and the magnetic backing plate in response to placing the magnetic backing plate below the index plate; and
placing the index plate on a sample surface in response to inverting the index plate and the magnetic backing plate.

2. The method of claim 1, wherein the sample surface comprises two-dimensional food.

3. The method of claim 1, further comprising pressing the index plate downward on the sample surface.

4. The method of claim 1, further comprising:
applying a uniform magnetic field to the magnetostrictive sensors in response to distributing the plurality of magnetostrictive sensors on the index plate; and
vibrating the index plate in response to applying the uniform magnetic field.

5. The method of claim 1, further comprising:
placing the index plate and the magnetic backing plate on a nonmagnetic cover plate in response to placing the index plate on the sample surface, wherein the cover plate is positioned above a first sensor coil;
removing the magnetic backing plate from the index plate in response to placing the index plate on the nonmagnetic cover plate;
removing the index plate from the nonmagnetic cover plate in response to removing the magnetic backing plate;
applying a varying magnetic field, using the first sensor coil, to a first magnetostrictive sensor positioned on the nonmagnetic cover plate in response to removing the index plate; and
detecting a frequency response of the first magnetostrictive sensor using the first sensor coil while applying the varying magnetic field.

6. The method of claim 5, further comprising determining whether a microorganism is present based on the frequency response of the first magnetostrictive sensor, wherein the first magnetostrictive sensor comprises a biorecognition element.

7. The method of claim 5, further comprising positioning the first sensor coil beneath the first magnetostrictive sensor, wherein applying the varying magnetic field comprises applying the varying magnetic field in response to positioning the first sensor coil.

8. The method of claim 7, further comprising:
positioning the first sensor coil beneath a second magnetostrictive sensor positioned on the nonmagnetic cover plate in response to detecting a frequency response of the first magnetostrictive sensor;
applying a varying magnetic field, using the first sensor coil, to the second magnetostrictive sensor in response to positioning the first sensor coil; and
detecting a frequency response of the second magnetostrictive sensor using the first sensor coil while applying the varying magnetic field.

9. The method of claim 5, wherein the cover plate is positioned above an array of sensor coils that includes the first sensor coil, and wherein each sensor coil of the array of sensor coils is aligned with a magnetostrictive sensor.

10. The method of claim 9, further comprising selecting the first sensor coil from the array of sensor coils with a low-loss radio-frequency switch, wherein applying the varying magnetic field comprises applying the varying magnetic field in response to selecting the first sensor coil.

11. The method of claim 10, wherein the array of sensor coils comprises a two-dimensional array, and wherein selecting the first sensor coil further comprises selecting the first sensor coil with a second low-loss radio frequency switch.

12. A system for contaminant detection, the system comprising:
a nonmagnetic cover plate;
an array of sensor coils positioned below the nonmagnetic cover plate; and
a controller coupled to the array of sensor coils, wherein the controller is to:
select a first sensor coil of the array of sensor coils, wherein the first sensor coil is positioned below a first magnetostrictive sensor that is positioned on top of the nonmagnetic cover plate;
apply a varying magnetic field with the first sensor coil to the first mangetostrictive sensor in response to selection of the first sensor coil; and
detect a frequency response of the first magnetostrictive sensor with the first sensor coil during application of the varying magnetic field.

13. The system of claim 12, wherein the controller is further to determine whether a microorganism is present based on the frequency response of the first magnetostrictive sensor, wherein the first magnetostrictive sensor comprises a biorecognition element.

14. The system of claim 12, wherein the controller is further to:
select a second sensor coil of the array of sensor coils in response to detection of the frequency response of the first magnetostrictive sensor, wherein the second sensor coil is positioned below a second magnetostrictive sensor that is positioned on top of the nonmagnetic cover plate;
apply a varying magnetic field with the second sensor coil to the second mangetostrictive sensor in response to selection of the second sensor coil; and
detect a frequency response of the second magnetostrictive sensor with the second sensor coil during application of the varying magnetic field.

15. The system of claim 12, wherein the array of sensor coils comprises a linear array.

16. The system of claim 12, wherein the array of sensor coils comprises a two-dimensional array.

17. The system of claim 12, wherein to select the first sensor coil comprises to select the first sensor coil with a low-loss radio-frequency switch.

18. The system of claim 17, wherein the radio-frequency switch comprises a solid-state semiconductor switch.

19. The system of claim 12, wherein:
the array of sensor coils comprises a two-dimensional array; and
to select the first sensor coil comprises to select the first sensor coil with a first low-loss radio-frequency switch and a second low-loss radio-frequency switch.

20. The system of claim 19, wherein:
each of the first switch and the second switch comprises a single-pole, multiple throw switch;
each sensor coil of the array of sensor coils comprises a first terminal and a second terminal;
the two-dimensional array of sensor coils comprises a plurality of rows and a plurality of columns, wherein each first terminal of the sensor coils in a row is coupled to a corresponding output terminal of the first switch, and wherein each second terminal of the sensor coils in a column is coupled to a corresponding output terminal of the second switch; and
to select the first sensor coil comprises to select a row that includes the first sensor coil with the first switch and a column that includes the first sensor coil with the second switch.
